(19) United States
(12) Patent Application Publication
(10) Pub. No.: US 2026/0233921 A1
(43) Pub. Date: Aug. 13, 2026

(54) MICROWAVE-INDUCED EXOTHERMIC COMPOSITION, MICROWAVE-INDUCED EXOTHERMIC LAYER, MICROWAVE-INDUCED EXOTHERMIC FILM, MICROWAVE-INDUCED EXOTHERMIC PACKAGE, AND METHOD FOR PRODUCING MICROWAVE-INDUCED EXOTHERMIC FILM

(71) Applicants: Shohta KOIDE, Shizuoka (JP); Takaki HAYASHI, Shizuoka (JP)

(72) Inventors: Shohta KOIDE, Shizuoka (JP); Takaki HAYASHI, Shizuoka (JP)

(21) Appl. No.: 19/155,990

(22) PCT Filed: Mar. 5, 2024
(86) PCT No.: PCT/JP2024/008182

§ 371 Date: Aug. 13, 2025

(30) Foreign Application Priority Data
Mar. 15, 2023 (JP) 2023-041347

(51) Int. Cl. B65D 81/34; C08L 25/18; C08L 65/00; H05B 6/64

(52) U.S. Cl. CPC B65D 81/3446; C08L 25/18; C08L 65/00; H05B 6/6408

(57) ABSTRACT

A microwave-induced exothermic composition includes an electroconductive polymer and a resin. The resin is at least one selected from the group consisting of a styrene-butadiene copolymer, an acrylonitrile-butadiene copolymer, a vinyl acetate resin, and a silicone resin.

### TECHNICAL FIELD

The disclosures herein generally relate to a microwave-induced exothermic composition, a microwave-induced exothermic layer, a microwave-induced exothermic film, a microwave-induced exothermic package, and a method for producing a microwave-induced exothermic film

### BACKGROUND ART

A package, in which a food product is accommodated, is heated and cooked by a microwave with the food product sealed inside the package. Therefore, a microwave-induced exothermic composition is used as a microwave-induced exothermic material that generates heat upon microwave irradiation, and is disposed in a heat-sealing section or printed section of the package. Use of the microwave-induced exothermic material facilitates the release of water vapor, which is generated from the heated food product, from the package to impart water-vapor permeability to the package.

As a microwave-induced exothermic composition used for a package, for example, use of a microwave-induced exothermic composition including a conductive organic compound, a dopant, and a resin in formation of a coating layer of a microwave-induced exothermic package film is disclosed (see, for example, PTL 1).

A package having an exothermic printed layer formed by using a microwave-induced exothermic composition available in the related art has a problem such that a resulting exothermic printed layer is easily peeled off from the package, as the exothermic printed layer is brought into contact with another object or impacts are applied to the exothermic printed layer during production. If the exothermic printed layer is peeled off from the package, water-vapor permeability of the package may be impaired, or a food product inside the package may be contaminated with the peeled exothermic printed layer. The exothermic printed layer may be peeled off from the package, for example, when the exothermic printed layer is brought into contact with a cardboard box for transportation or another package, when blocking occurs within a roll of the package, or when impacts are applied to the exothermic printed layer at the time of formation of an opening for releasing water vapor.

Moreover, a package including an exothermic printed layer formed with a microwave-induced exothermic composition available in the related art has characteristics such that the exothermic printed layer is more easily peeled off from the package particularly when the exothermic printed layer is brought into contact with water. For example, the exothermic printed layer may be peeled off from the package by water vapor generated from a food product heated by microwaves, or moisture in a fridge storage environment, or moisture from condensation.

One embodiment of the present disclosure aims to provide a microwave-induced exothermic composition that achieves excellent adhesion to a base and excellent water resistance, as well as high water-vapor permeability, when the microwave-induced exothermic composition is used for a microwave-induced exothermic film or a microwave-induced exothermic package.

### CITATION LIST

### Patent Literature

PTL 1: Japanese Patent No. 6713797

### DISCLOSURE OF INVENTION

In one embodiment, a microwave-induced exothermic composition includes an electroconductive polymer and a resin. The resin is at least one selected from the group consisting of a styrene-butadiene copolymer, an acrylonitrile-butadiene copolymer, a vinyl acetate resin, and a silicone resin.

One embodiment of the present disclosure can provide a microwave-induced exothermic composition that achieves excellent adhesion to a base and excellent water resistance, as well as high water-vapor permeability, when the microwave-induced exothermic composition is used for a microwave-induced exothermic film or a microwave-induced exothermic package.

### BRIEF DESCRIPTION OF DRAWINGS

FIG. 1 is a schematic cross-sectional view illustrating one example of a microwave-induced exothermic film of one embodiment of the present disclosure.

FIG. 2 is a schematic cross-sectional view illustrating another example of the microwave-induced exothermic film of the embodiment.

FIG. 3 is a schematic cross-sectional view illustrating yet another example of the microwave-induced exothermic film of the embodiment.

FIG. 4 is a schematic cross-sectional view illustrating yet another example of the microwave-induced exothermic film of the embodiment.

FIG. 5 is a schematic cross-sectional view illustrating yet another example of the microwave-induced exothermic film of the embodiment.

FIG. 6 is a perspective view illustrating an example of a microwave-induced exothermic package of one embodiment of the present disclosure.

FIG. 7 is a perspective view illustrating another example of the microwave-induced exothermic package of the embodiment.

### MODE FOR CARRYING OUT THE INVENTION

In the following, embodiments of the present invention will be described with reference to the accompanying drawings. Further, the present invention is not limited to these embodiments, but various variations and modifications may be made without departing from the scope of the present invention. In the present specification, a numerical range specified includes the upper limit and the lower limit of the described range, unless otherwise stated.

### <Microwave-Induced Exothermic Composition>

Embodiments of the microwave-induced exothermic composition of the present disclosure will be described hereinafter.

According to one embodiment of the present disclosure, the microwave-induced exothermic composition includes an electroconductive polymer and a resin that is at least one selected from the group consisting of a styrene-butadiene copolymer, an acrylonitrile-butadiene copolymer, a vinyl acetate resin, and a silicone resin. When the above-described microwave-induced exothermic composition is used for a microwave-induced exothermic film or a microwave-induced exothermic package, excellent adhesion to a base and excellent water resistance are achieved. In addition, heat is generated by microwave irradiation during microwave heating to easily form an opening so that high water-vapor permeability is also achieved.

According to one embodiment of the present disclosure, the microwave-induced exothermic composition includes an electroconductive polymer and a resin. The microwave-induced exothermic composition may further include other components.

### (Electroconductive Polymer)

The electroconductive polymer preferably includes at least one selected from the group consisting of polyanilines, polypyrroles, polythiophenes, polyacetylenes, polyisothianaphthenes, polyethylene vinylenes, polyparaphenylenes, polyphenylene vinylenes, polyfluorenes, polycarbazoles, polyacenes, polythiazyls, polyethylene vinylenes, polyphenylene sulfides, polyperinaphthalenes, polyacrylonitriles, polyoxadiazoles, polyindoles, polyazulenes, polyfurans, phthalocyanines and derivatives of phthalocyanines, polysilanes, polygermanes, porphyrins and derivatives of porphyrins, graphenes and derivatives of graphenes, perylene derivatives, tetrathiafulvalene derivatives, sulfur-containing heterocyclic compounds, oxygen-containing heterocyclic compound, nitrogen-containing heterocyclic compound, tetracyanoquinodimethane derivative, fullerenes, carbon nanotubes, and quinones.

Among the above-listed examples, pi-conjugated electroconductive polymer compounds including a pi-conjugated principle chain, such as polythiophenes, polypyrroles, polyanilines, polyacetylenes, polyphenylenes, polyphenylene vinylenes, polyacenes, and polythiophene vinylenes are more preferred. In view of easiness of polymerization and stability in air, polythiophenes, polypyrroles, and polyanilines are yet more preferred.

Examples of the polyanilines include polyaniline, poly(2-methylaniline), poly(3-methylaniline), poly(2-ethylaniline), poly(3-ethylaniline), poly(2-methoxyaniline), poly(3-methoxyaniline), poly(2-ethoxyaniline), poly(3-ethoxyaniline), poly(N-methylaniline), poly(N-propylaniline), poly(N-phenyl-1-naphthylaniline), poly(8-anilino-1-naphthalenesulfonic acid), and poly(7-anilino-4-hydroxy-2-naphthalenesulfonic acid).

Examples of the polypyrroles include polypyrrole, poly(l-methylpyrrole), poly(3-methylpyrrole), poly(l-ethylpyrrole), poly(3-ethylpyrrole), poly(l-methoxypyrrole), poly(3-methoxypyrrole), poly(l-ethoxypyrrole), and poly(3-ethoxypyrrole).

Examples of the polythiophenes include polythiophene, polyisothiophene, polyethylene dioxythiophene (PEDOT), polyisonaphtothiophene, polydodecylthiophene, poly(3-methylthiophene), poly(3-hexylthiophene), poly(3-methoxythiophene), poly(3-ethoxythiophene), poly(3-hexylthiophene-2,5-diyl) (P3HT), poly(3-octylthiophene-2,5-diyl) (P3OT), poly(3-dodecylthiophene-2,5-diyl) (P3DDT), poly(3-(2-methoxyethoxy) ethoxymethylthiophene-2,5-diyl), poly [(N-dodecyldioxopyrrolothiophene)-alt-(thiophene)] (PDT), poly(3-undecyl-2,2′-bithiophene), and poly(4-undecyl-2,2′-bithiophene).

Examples of the polyacetylenes include polyacetylene and polydiacetylene.

Examples of the polyisothianaphthenes include polyisothianaphthene.

Examples of the poly(thienylenevinylene) include poly(thienylenevinylene).

Examples of the polyparaphenylene include polyparaphenylene and poly(2,5-dimethoxy-p-phenylene).

Examples of the polyphenylene vinylenes include polyparaphenylene vinylene, poly(2,5-dimethoxyphenylvinylene) and polynaphthalene vinylene.

Examples of the polyfluorenes include polyfluorene and poly(C1-C20 alkyl fluorene).

Examples of the polycarbazoles include polycarbazole.

Examples of the polyacenes include naphthacene, pentacene, hexacene, heptacene, dibenzopentacene, tetrabenzopentacene, pyrene, dibenzopyrene, chrysene, perylene, coronene, terrylene, ovalene, quaterrylene, circumanthracene, and derivatives of the foregoing.

Other examples include: electroconductive polymer compounds, such as polythiazyl, polyethylene vinylene, polyphenylene sulfide, polyperinaphthalene, polyacrylonitrile, polyoxadiazole, polyindoles (e.g., polyindole), polyazulenes (e.g., polyazulene), polyfurans (e.g., polyfuran, and polybenzofuran), phthalocyanines (e.g., phthalocyanine, copper phthalocyanine, zinc phthalocyanine, titanyl phthalocyanine, and poly [Fe phthalocyanine (tetrazine)]) and derivatives of the phthalocyanines, polysilane compounds, and polygermane compounds; and low-molecular-weight electroconductive compounds, such as porphyrins (e.g., porphyrin, tetramethylporphyrin, tetraphenylporphyrin, diazo tetrabenzoporphyrin, monoazo tetrabenzoporphyrin, diazo tetrabenzoporphyrin, triazo tetrabenzoporphyrin, octaethylporphyrin, octaalkylthioporphyrazine, octaalkylaminoporphyrazine, hemiporphyrazine, and chlorophyll) and derivatives of the porphyrins, graphenes and derivatives of the graphenes, perylene derivatives (e.g., bis(benzimidazol) perylene), tetrathiafulvalene derivatives (e.g., dibenzotetrathiafulvalene), sulfur-containing heterocyclic compounds, oxygen-containing heterocyclic compounds, nitrogen-containing heterocyclic compounds (e.g., carbazole), tetracyanoquinodimethane derivatives, fullerene derivatives, carbon nanotube derivatives, cyanine dyes, merocyanine dyes, and quinones (e.g., benzoquinone, and naphthoquinone).

### (Resin)

As the resin, a styrene-butadiene copolymer, an acrylonitrile-butadiene copolymer, a vinyl acetate resin, a silicone resin, etc., may be used. The above-listed resins may be used alone or in combination. Among the above-listed examples, an acrylonitrile-butadiene copolymer and a silicone resin are preferred because of excellent adhesion to a base and excellent resistance of an image formed. Specific examples of the resin are listed, but the resin is not limited to the below-listed resins.

Examples of the styrene-butadiene copolymer include Nipol series (available from Zeon Corporation), SBL series (available from ENEOS Materials Corporation), Nalstar SBR/MBR series (available from NIPPON A&L INC.), LACSTAR series (available from DIC Corporation), and SB Latex series (available from Asahi Kasei Corporation).

Examples of the acrylonitrile-butadiene copolymer include Cyatex NBR series (available from NIPPON A&L INC.) and Nipol series (available from Zeon Corporation).

Examples of the vinyl acetate resin include VINYBLAN series (available from Nisshin Chemical Co., Ltd.), CEVIAN-A series (available from Daicel Miraizu Ltd.), and Polysol series (available from Resonac Holdings Corporation).

Examples of the silicone resin include DOWSIL series (available from Dow Toray Co., Ltd.) and POLON series (available from Shin-Etsu Chemical Co., Ltd.).

To achieve desired adhesion to a base, a glass transition temperature Tg of the resin is preferably −20 degrees Celsius or higher, more preferably −15 degrees Celsius or higher, and yet more preferably 20 degrees Celsius or higher. When the glass transition temperature Tg of the resin is-20 degrees Celsius or higher, desired adhesion to a base can be achieved. The upper limit of the glass transition temperature Tg of the resin is not particularly limited, except that desired adhesion to a base is achieved. The upper limit of the glass transition temperature Tg of the resin may be lower than 25 degrees Celsius.

An amount of the resin is preferably from 10% by mass to 90% by mass, more preferably from 20% by mass to 80% by mass, and yet more preferably from 30% by mass to 70% by mass, relative to a solid content of the microwave-induced exothermic composition. When the amount of the resin is within the above-mentioned range, desired water resistance and water-vapor permeability are achieved.

### (Other Components)

### ((Dopant))

The dopant is not particularly limited, except that the dopant has a structure that functions as an acceptor or a donor relative to the electroconductive polymer. The acceptor is the structure that is likely to accept electrons, and the donor is the structure that is likely to supply electrons.

The electroconductive polymer is doped with some of functional groups included in the dopant so that the dopant contributes to conductivity of the electroconductive polymer. Examples of the functional groups included in the dopant include carboxyl groups, hydroxyl groups, mercapto groups, amino groups, sulfino groups, and sulfonium groups.

The carboxyl group-containing dopant is preferably a carboxylic acid aromatic compound or carboxylic acid condensed ring aromatic compound, in which an aromatic ring or a condensed aromatic ring is included within a molecular structure. The aromatic ring or condensed ring aromatic compound has many resonance structures and suppresses a hydrolysis reaction. Since the carboxylic acid aromatic compound or carboxylic acid condensed ring aromatic compound is used, a microwave-induced exothermic composition having improved water resistance can be obtained.

The carboxylic acid aromatic compound or carboxylic acid condensed ring aromatic compound is not particularly limited. Examples of the carboxylic acid aromatic compound and carboxylic acid condensed ring compound include: carboxylic acid aromatic compounds, such as ortho-phthalic acid, hemimellitic acid, trimesic acid, mellophanic acid, benzenepentacarboxylic acid, and mellitic acid; carboxylic acid aromatic compound derivatives, such as 4-sulfophthalic acid; carboxylic aromatic condensed compounds, such as compounds obtained by substituting naphthalene with only carboxylic acid (e.g., 1,4-naphthalenedicarboxylic acid, 2,3-naphthalenedicarboxylic acid, 2,6-naphthalenedicarboxylic acid, and 1,8-naphthalenedicarboxylic acid anhydride) and derivatives of the foregoing; carboxylic acid condensed compounds (e.g., 4-chloro-1,8-naphthalenedicarboxylic acid anhydride, 4-sulfo-1,8-naphthalenedicarboxylic acid anhydride, and naphthalene-1,4,5,8-tetracarboxylic acid) and derivatives of the foregoing; anthracene ring-containing compounds, such as 2,3-anthracenedicarboxylic acid anhydride; and carboxylated polycyclic aromatic hydrocarbons (e.g., naphthacene, pentacene, benzopyrene, benzopyrene, chrysene, pyrene, triphenylene, corannulene, coronene, and ovalene) and derivatives of the carboxylated polycyclic aromatic hydrocarbons.

Examples of the hydroxyl group-containing dopant include salicylic acid, m-hydroxybenzoic acid, p-hydroxybenzoic acid, 4-hydroxyphthalic acid, 3-hydroxyphthalic anhydride, 3,6-dihydroxyphthalic acid, phenolsulfonic acid, 3-hydroxy-2,7-naphthalenedicarboxylic acid, and derivatives of the foregoing.

Examples of the mercapto group-containing dopant include thioglycolic acid, mercaptosuccinic acid, 2-mercaptobutyric acid, 4-mercaptobutyric acid, 2-mercaptoethanol, 2-mercaptobenzoic acid, 3-mercaptobenzoic acid, 4-mercaptobenzoic acid, o-aminothiophenol, m-aminothiophenol, p-aminothiophenol, 2-hydroxythiophenol, 3-hydroxythiophenol, 4-hydroxythiophenol, and derivatives of the foregoing.

Examples of the amino group-containing dopant include aminomethanesulfonic acid, 1-amino-2-naphthol-4-sulfonic acid, 2-amino-5-naphthol-7-sulfonic acid, 3-aminopropanesulfonic acid, N-cyclohexyl-3-aminopropanesulfonic acid, o-aminobenzenesulfonic acid, m-aminobenzenesulfonic acid, p-aminobenzenesulfonic acid, 4-amino-2-chlorotoluene-5-sulfonic acid, 4-amino-3-methylbenzene-1-sulfonic acid, 4-amino-5-methoxy-2-methylbenzenesulfonic acid, 2-amino-5-methylbenzene-1-sulfonic acid, 4-amino-2-methylbenzene-1-sulfonic acid, 5-amino-2-methylbenzene-1-sulfonic acid, 4-amino-3-methylbenzene-1-sulfonic acid, polycarboxylic acid (e.g., polyacrylic acid, polymethacrylic acid, and polymaleic acid), and derivatives of the foregoing.

Examples of the sulfino group-containing dopant include methanesulfinic acid, ethanesulfinic acid, isopropylsulfinic acid, benzenesulfinic acid, p-toluenesulfinic acid, cyclopropanesulfinic acid, derivatives of p-chlorobenzenesulfinic acid, hydroxymethanesulfinic acid, L-cysteinesulfinic acid, 2-aminoethanesulfinic acid, and derivatives of the foregoing.

Examples of the sulfonium group-containing dopant include low-molecular-weight sulfonic acid and salts of the low molecular weight sulfonic acid, and sulfonic acid group-containing high-molecular-weight acids and salts of the sulfonic acid group-containing high-molecular-weight acids.

Examples of the low-molecular-weight sulfonic acid include alkylsulfonic acid, benzenesulfonic acid, naphthalenesulfonic acid, anthraquinonesulfonic acid, camphorsulfonic acid, and derivatives of the foregoing. The low-molecular-weight sulfonic acid is particularly preferably a low-molecular-weight organic acid having a molecular weight of 1,000 or less.

Examples of the alkylsulfonic acid include 2-acrylamide-2-methylpropanesulfonic acid, dodecylbenzenesulfonic acid, and derivatives of the foregoing.

Examples of the benzenesulfonic acid include toluenesulfonic acid, styrenesulfonic acid, and derivatives of the foregoing.

Examples of the nephthalenesulfonic acid include 1-naphthalenesulfonic acid, 2-naphthalenesulfonic acid, 1,3-naphthalenedisulfonic acid, 1,3,6-naphthalenetrisulfonic acid, 6-ethyl-1-naphthalenesulfonic acid, and derivatives of the foregoing.

Examples of the anthraquinonesulfonic acid include anthraquinone-1-sulfonic acid, anthraquinone-2-sulfonic acid, anthraquinone-2,6-disulfonic acid, 2-methylanthraquinone-6-sulfonic acid, and derivatives of the foregoing.

Examples of the camphorsulfonic acid include (+)-10-camphorsulfonic acid, (−)-10-camphorsulfonic acid, and derivatives of the foregoing. Moreover, the camphorsulfonic acid may be a racemate.

Among the above-listed examples, benzenesulfonic acid, toluenesulfonic acid, and naphthalenesulfonic acid are preferred. The above-listed examples may be used alone or in combination.

In the case where the low-molecular-weight sulfonic acid is alkylsulfonic acid, benzenesulfonic acid, naphthalenesulfonic acid, anthraquinonesulfonic acid, camphorsulfonic acid, or a derivative of the low-molecular-weight sulfonic acid, the low-molecular-weight sulfonic acid may be a salt of a low-molecular-weight organic acid. Examples of the salt of the low-molecular-weight organic acid include ammonium salts and sodium salts.

Examples of the high-molecular-weight acid of the sulfonic acid group-containing high-molecular-weight acid include: polycarboxylic acid, such as polyacrylic acid, polymethacrylic acid, and polymaleic acid; polysulfonic acid, such as polyvinyl sulfonate and polystyrene sulfonate; and copolymers including any of the foregoing as structural units. Among the above-listed examples, polystyrene sulfonate (PSS) is preferred. The above-listed high-molecular-weight acids may be used alone or in combination.

A weight average molecular weight (Mw) of the high-molecular-weight acid is preferably from 2,000 to 500,000, and more preferably from 10,000 to 200,000.

An amount of the dopant in the microwave-induced exothermic composition is preferably from 20 parts by mass to 3,000 parts by mass, and more preferably from 30 parts by mass to 1,000 parts by mass, relative to 100 parts by mass of the electroconductive polymer.

As a dopant, a single dopant may be used, or two or more dopants may be used in combination.

### (Solvent)

The solvent is not particularly limited, except that the solvent can retain the electroconductive polymer in a dissolved and dispersed state. The solvent may be a single solvent, or a mixture of two or more solvents. The solvent may be appropriately selected from protic polar solvents (e.g., water, methanol, ethanol, propanol, and acetic acid), and aprotic non-polar solvents. The above-listed examples may be used alone or in combination.

As a solvent, a high boiling point solvent, which has a melting point of 100 degrees Celsius to 350 degrees Celsius, is preferably used.

The high boiling point solvent is not particularly limited, except that the high boiling point solvent is a solvent having a melting point of from 100 degrees Celsius to 350 degrees Celsius. The high boiling point solvent may be a single solvent, or a mixture of two or more solvents. Examples of the high boiling point solvent include, but are not limited to, ethylene glycol, diethylene glycol, diethylene glycol monobutyl ether, dibutylene glycol monoethyl ether, diethylene glycol monoethyl ether acetate, diethylene glycol monomethyl ether, DMSO, formamide, glycerin, propylene glycol, 1,3-butanediol, and dipropylene glycol. Among the above-listed examples, ethylene glycol, diethylene glycol, DMSO, glycerin, propylene glycol, 1,3-butanediol, and dipropylene glycol are preferably used.

An amount of the solvent in the microwave-induced exothermic composition is preferably from 0.01% by mass to 50% by mass, and more preferably from 1% by mass to 10% by mass. The amount of the solvent in the microwave-induced exothermic composition is from 0.01% by mass to 50% by mass, an exothermic effect can be improved, and drying speed of the microwave-induced exothermic composition is increased to improve productivity.

The microwave-induced exothermic composition is preferably in a dissolved or stably dispersed state. The microwave-induced exothermic composition may be in a temporarily dispersed state by mechanical stirring.

For the purpose of improving design, applicability, required physical properties (e.g., hue), ink stability, and printability, the microwave-induced exothermic composition of the present disclosure may include a colorant, a solvent, water, wax, a pigment dispersing agent, a resin, a crosslinking agent, inorganic fillers, organic fillers, a defoaming agent, a leveling agent, an anti-blocking agent, an antistatic agent, a pH regulator, slip additives, a plasticizer, a tackifier, etc. The above-listed components may be appropriately selected, except that the components used do not adversely affect properties of the microwave-induced exothermic composition.

### ((Colorant))

As the colorant, a pigment, a dye, or a mixture of the foregoing may be added.

Examples of the pigment include: inorganic pigments, such as titanium oxide, red iron oxide, barium sulfate, calcium carbonate, silica, zinc oxide, zinc sulfide, mica, talc, pearl, aluminum, and carbon black; organic pigments, such as phthalocyanine-based pigments, insoluble azo-pigments, condensed azo-pigments, dioxazine-based pigments, anthraquinone-based pigments, quinacridone-based pigments, perylene-based pigments, perinone-based pigments, and thioindigo-based pigment; and other various fluorescent pigments, metal powder pigments, and extender pigments. The above-listed pigments may be used alone or in combination.

The dye is preferably a dye that is dissolved or dispersed in a solvent. As the dye, a single dye may be used, or two or more dyes are used in combination. Among the above-listed examples of the colorant, the pigment is preferably used in view of durability. Use of the colorant in the microwave-induced exothermic composition is very effective in view of color variations and design.

### ((Solvent))

The microwave-induced exothermic composition may include a solvent for imparting appropriate fluidity during printing or adjusting a viscosity. The solvent is not particularly limited, as long as the solvent can dissolve or disperse constituent components of the microwave-induced exothermic composition, and can retain fluidity of the microwave-induced exothermic composition. The solvent is appropriately selected from typically used organic solvents and water.

Examples of the organic solvent include aromatic hydrocarbon-based solvent (e.g., toluene, and xylene), aliphatic hydrocarbon-based solvents (e.g., hexane, cyclohexane, methylcyclohexane, and ethylcyclohexane), alcohol-based solvents (e.g., methanol, ethanol, isopropyl alcohol (IPA), n-propyl alcohol, 1-butanol, 2-butanol, isobutanol, and tert-butanol), ester-based solvents (e.g., ethyl acetate, n-propyl acetate, isopropyl acetate, butyl acetate, isobutyl acetate, sec-butyl acetate, and tert-butyl acetate), ketone-based solvents (e.g., acetone, methylethylketone (MEK), methyl isobutyl ketone, and cyclohexanone), glycol ether-based solvents (e.g., ethylene glycol monomethyl ether, ethylene glycol monoethyl ether, ethylene glycol dimethyl ether, ethylene glycol monobutyl ether, propylene glycol monomethyl ether, propylene glycol monoethyl ether, propylene glycol monopropyl ether, and propylene glycol monobutyl ether), and esterified (e.g., esterified with acetic acid) products of the glycol ether-based solvent (e.g., ethylene glycol monomethyl ether acetate, ethylene glycol monoethyl ether acetate, ethylene glycol monobutyl ether acetate, diethylene glycol monoethyl ether acetate, diethylene glycol monobutyl ether acetate, propylene glycol monomethyl ether acetate, and propylene glycol monoethyl ether acetate). Among the above-listed examples, toluene, ethyl acetate, n-propyl acetate, n-propyl alcohol, isopropyl alcohol, methyl ethyl ketone, and water are more preferred in view of printability and ready availability. The above-listed examples may be used alone or in combination.

An amount of the solvent in the microwave-induced exothermic composition is preferably from 30% by mass to 99.99% by mass, and more preferably from 40% by mass to 99.9% by mass.

### ((Wax))

The wax is not particularly limited, and may be appropriately selected according to the intended purpose. The wax may be selected from wax and monomeric organic hydrophobic materials. Examples of the wax include carnauba wax, bees wax, montan wax, paraffin wax, and synthetic wax. Examples of the monomeric organic hydrophobic materials include biphenyl, O-terphenyl, naphthalene, and anthracene. The above-listed examples may be used alone or in combination.

### ((Pigment Dispersing Agent))

The pigment dispersing agent is not particularly limited, and may be appropriately selected according to the intended purpose. Examples of the pigment dispersing agent include anionic surfactants, cationic surfactants, and nonionic surfactants. The above-listed examples may be used alone or in combination.

### ((Other Resins))

As other resins, resins other than the above-described styrene-butadiene copolymer, acrylonitrile-butadiene copolymer, vinyl acetate resin, and silicone resin may be used.

### ((Crosslinking Agent))

The crosslinking agent is not particularly limited, and may be appropriately selected according to the intended purpose. Examples of the crosslinking agent include hydrazide-based crosslinking agents, isocyanate-based crosslinking agents, epoxy-based crosslinking agents, carbodiimide-based crosslinking agents, silane coupling-based crosslinking agents, oxazoline-based crosslinking agents, aziridine-based crosslinking agents, imine-based crosslinking agents, metal chelate-based crosslinking agents, glyoxal-based crosslinking agents, and methylol-based crosslinking agents. The above-listed examples may be used alone or in combination. Among the above-listed examples, isocyanate-based crosslinking agents, carbodiimide-based crosslinking agents, epoxy-based crosslinking agents, and aziridine-based crosslinking agents are preferred.

As described above, the microwave-induced exothermic composition of the present disclosure includes an electroconductive polymer and a resin that is at least one selected from the group consisting of a styrene-butadiene copolymer, an acrylonitrile-butadiene copolymer, a vinyl acetate resin, and a silicone resin. A microwave-induced exothermic layer formed using the microwave-induced exothermic composition of the present disclosure easily generates heat through microwave irradiation to achieve high water-vapor permeability. When the microwave-induced exothermic layer is disposed to overlap with a heat-sealing section of a microwave-induced exothermic film, therefore, an opening is easily formed in the heat-sealing section due to fusion or shrinkage of the film. When the microwave-induced exothermic layer is disposed at a central section of a microwave-induced exothermic film, an opening is easily formed in the central section by breakage of the microwave-induced exothermic film.

When the microwave-induced exothermic composition is used for a microwave-induced exothermic layer of a microwave-induced exothermic film or microwave-induced exothermic package, the microwave-induced exothermic composition has excellent adhesion to a base, the resulting microwave-induced exothermic film or microwave-induced exothermic package has excellent water resistance, and the resulting microwave-induced exothermic layer is not easily peeled off even when the microwave-induced exothermic layer is brought into contact with water. Accordingly, use of the microwave-induced exothermic composition of the present disclosure can minimize breakage of a microwave-induced exothermic layer of a microwave-induced exothermic film or microwave-induced exothermic package, as well as minimizing heat generation failures and contamination of a food product.

The resin in the microwave-induced exothermic composition of the present disclosure may have a glass transition temperature Tg of −20 degrees Celsius or higher. The microwave-induced exothermic composition of the present disclosure including the above-described resin can maintain flexibility of the resin and enhance adhesion to a base. When the microwave-induced exothermic composition of the present disclosure is used for a microwave-induced exothermic layer of a microwave-induced exothermic film or microwave-induced exothermic package, therefore, adhesion of the microwave-induced exothermic layer to a base can be further improved.

In the microwave-induced exothermic composition of the present disclosure, an amount of the resin may be from 10% by mass to 90% by mass relative to a solid content of the microwave-induced exothermic composition. Use of the microwave-induced exothermic composition of the present disclosure can improve high water resistance without causing peeling of a microwave-induced exothermic layer as contacted with water. When the microwave-induced exothermic composition of the present disclosure is used for a microwave-induced exothermic layer of a microwave-induced exothermic film or microwave-induced exothermic package, therefore, high water-vapor permeability is easily achieved, and water resistance can be improved.

The microwave-induced exothermic composition of the present disclosure may further include a dopant. Therefore, the dopant-doped electroconductive polymer can be securely incorporated in the microwave-induced exothermic composition so that heat is easily generated through microwave irradiation. When the microwave-induced exothermic composition of the present disclosure is used for a microwave-induced exothermic layer of a microwave-induced exothermic film or microwave-induced exothermic package, an opening is easily formed in the microwave-induced exothermic layer to achieve high water-vapor permeability, as well as improving water resistance.

The microwave-induced exothermic composition of the present disclosure may further include a high boiling point solvent having a boiling point of from 100 degrees Celsius to 350 degrees Celsius. Since the high boiling point solvent is included in the microwave-induced exothermic composition of the present disclosure, the electroconductive polymer is more uniformly aligned within the microwave-induced exothermic composition in the course of a drying process of the microwave-induced exothermic composition. When the microwave-induced exothermic composition is used for a microwave-induced exothermic layer of a microwave-induced exothermic film or microwave-induced exothermic package, therefore, high water-vapor permeability is securely achieved, as well as ensuring water resistance.

### <Microwave-Induced Exothermic Layer>

According to one embodiment of the present disclosure, the microwave-induced exothermic layer is a layer (coating layer) formed by using the microwave-induced exothermic composition of the present disclosure. Specifically, the microwave-induced exothermic layer includes an electroconductive polymer and a resin, where the resin is at least one selected from the group consisting of a styrene-butadiene copolymer, an acrylonitrile-butadiene copolymer, a vinyl acetate resin, and a silicone resin.

According to the above-described embodiment of the present disclosure, a microwave-induced exothermic layer having excellent adhesion to a base and excellent water resistance, as well as high water-vapor permeability, can be provided.

The microwave-induced exothermic layer of the present disclosure may be formed on at least one face of a base, for example, by coating.

The base is not particularly limited. As the base, a base identical to the base of the microwave-induced exothermic film may be used.

The coating method is not particularly limited, and may be selected from typical coating methods.

A thickness of the microwave-induced exothermic layer of the present disclosure is preferably from 0.01 μm (micrometers) to 10 μm (micrometers), and more preferably from 0.05 μm (micrometers) to 3 μm (micrometers). When the film thickness of the microwave-induced exothermic layer is from 0.01 μm (micrometers) to 10 μm (micrometers), heat is sufficiently generated, and suitable blocking resistance is achieved.

The microwave-induced exothermic layer of the present disclosure is a coating layer formed by using the microwave-induced exothermic composition of the present disclosure. Therefore, the microwave-induced exothermic layer generates heat through microwave irradiation during microwave heating so that an opening is easily formed in a microwave-induced exothermic film or microwave-induced exothermic package to achieve high water-vapor permeability, as well as achieving excellent adhesion to a base and excellent water resistance.

### <Microwave-Induced Exothermic Film>

According to one embodiment of the present disclosure, the microwave-induced exothermic film includes a base and a microwave-induced exothermic layer, and may further include a sealant and an adhesive layer, as necessary. The microwave-induced exothermic layer is the above-described microwave-induced exothermic layer of the present disclosure.

According to the above-described embodiment of the present disclosure, a microwave-induced exothermic film achieving excellent adhesion to a base and excellent water resistance, as well as high water-vapor permeability, can be provided.

The base is preferably at least one selected from the group consisting of paper, plastic films or sheets, and laminates to which sealability is imparted. Examples of the plastic films or sheets include polyester films (e.g., polyethylene terephthalate (PET), and polyethylene naphthalate (PEN)), polyolefin films (e.g., polyethylene, polypropylene, ethylene-vinyl acetate), polystyrene films, alcohol-based films (e.g., ethylene-vinyl alcohol, and polyvinyl alcohol), polyamide films, barrier polyamide films where a barrier layer is disposed between polyamide films, cellophanes, moisture-proof cellophanes, transparent vapor deposition polyester films or transparent vapor deposition polyamide films, where a vapor deposition layer of alumina or silica is deposited on a PET film or polyamide film, and various coating films obtained by coating polyvinylidene chloride resins, polyvinyl alcohol resins, polyacrylic acid resins, anchor coating resins, etc. The above-listed examples may be oriented films or cast films. The base may have a laminate structure where one or more selected from the above-listed films are stacked. The base is appropriately selected considering desired mechanical strength or dimensional stability.

Moreover, corona processing, low-temperature plasma processing, frame processing, solvent processing, or coating may be performed on a coated surface of the base to improve adhesion with the microwave-induced exothermic composition. Alternatively, the base may be selected from surface-treated films to which any of the above-listed treatments has been already performed.

The base may be a laminate where thermoplastic resin films or sheets are stacked by dry laminating, non-solvent laminating, or extrusion laminating, or a laminate where films or sheets are stacked together via an adhesive, or any combination of the foregoing. The base may be a monoaxially oriented film, an easy-cut film, a stretchable film, or a shrinkable film.

Moreover, the base may be a laminate to which sealability is imparted. Examples of a method for imparting sealability include: a method where a sealant film or sheet available in the related art is bonded to the base; and a method where the base is coated with a resin by extrusion laminating. The layer to which sealability is imparted by the above-listed methods is referred to as a sealant.

Moreover, the base may be subjected to blasting in advance.

A thickness of the base is not particularly limited, except that the thickness of the base is within a range that does not adversely affect printability and winding suitability. The thickness of the base is preferably from 5 μm (micrometers) to 300 μm (micrometers), and more preferably from 6 μm (micrometers) to 250 μm (micrometers).

The microwave-induced exothermic film according to one embodiment of the present disclosure may preferably include a sealant, as necessary.

The sealant is preferably a layer including a resin having sealability. Examples of the resin used in the sealant include thermoplastic resins, such as polyethylene resins (e.g., LDPE, LLDPE, HDPE, and metallocene polyethylene), polypropylene resins, ethylene-vinyl acetate copolymers, ionomer resins, ethylene-acrylic acid copolymers, ethylene-ethyl acrylate copolymers, ethylene-methyl acrylate copolymers, ethylene-methacrylic acid copolymers, ethylene-methyl methacrylate copolymers, ethylene-propylene copolymers, methyl terpene polymers, acid-modified polyolefin resins (e.g., polyethylene or polypropylene modified with maleic acid or fumaric acid), and polystyrene resins. The above-listed resins may be used alone or in combination.

A film including any of the above-listed resins or a laminate including two or more films including any of the above-listed resins may be formed through laminating (e.g., dry laminating, wet laminating, non-solvent laminating, and thermal laminating), resin coating (e.g., extrusion laminating), coating of a heat-sealing agent, or bonding via a hot-melt adhesive. The film or laminate including any of the above-listed resins is not necessarily formed over an entire surface of the microwave-induced exothermic film, and may be formed on a sealing area.

Examples of the film include polyolefin films, such as polyethylene, polypropylene, mixed resins of polyethylene and polypropylene, ethylene-vinyl acetate copolymer resins, ethylene-(meth)acrylic acid copolymer resins, ethylene-methyl (meth)acrylate copolymer resins, ethylene-ethyl (meth)acrylate copolymer resins, and ethylene-vinyl alcohol copolymer resins.

Examples of the resin used for resin coating or the resin of a hot-melt adhesive used for extrusion laminating include thermoplastic resins, such as polyethylene resins (e.g., LDPE, LLDPE, and HDPE), polypropylene resins, ethylene-vinyl acetate copolymers, ionomer resins, ethylene-acrylic acid copolymers, ethylene-ethyl acrylate copolymers, ethylene-methyl acrylate copolymers, ethylene-methacrylic acid copolymers, ethylene-methyl methacrylate copolymers, ethylene-propylene copolymers, methyl terpene polymers, acid-modified polyolefin resins (e.g., polyethylene or polypropylene modified with maleic acid or fumaric acid), and polystyrene resins. The above-listed resins may be used alone or in combination.

A thickness of the sealant is not particularly limited. In view of sealability, cost, and productivity, the thickness of the film as the sealant is preferably from 2 μm (micrometers) to 200 μm (micrometers), the thickness of the resin coating by extrusion laminating, which serves as the sealant, is preferably from 1 μm (micrometer) to 100 μm (micrometers), the thickness of the coated heat-sealant serving as the sealant is preferably from 0.1 μm (micrometers) to 10 μm (micrometers), and the thickness of the coated hot-melt adhesive serving as the sealant is preferably from 1 μm (micrometers) to 50 μm (micrometers).

The microwave-induced exothermic film of the present disclosure may further include an adhesive layer. For example, the adhesive layer is disposed between the base and another base, or between the base and the sealant. The adhesive layer is configured to bond two layers together using an adhesive or pressure sensitive adhesive (including wax and hot-melt adhesives) having adhesiveness or stickiness.

Examples of the resin used to form the adhesive layer include the resins having sealability used for formation of the above-described sealant, urethane resins, butadiene resins, polyethylene imide resins, isocyanate resins, and chelates. As the resin used to form the adhesive layer, a commercially available adhesive may be used. Moreover, the adhesive may be a one component adhesive where a main component and a curing agent are mixed, or a two component adhesive including a main component and a curing agent separately. In the case where the resin used to form the adhesive layer is a two component adhesive, a mixing ratio of the main component and the curing agent is appropriately adjusted to mix the main component with the curing agent.

The microwave-induced exothermic film of the present disclosure may further include an overcoating layer on the microwave-induced exothermic layer.

The microwave-induced exothermic film according to one embodiment of the present disclosure may further include other layers. Examples of other layers include OPP films, ONY films, PET films, EVOH films, PVA films, cellophane films, barrier nylon films, oriented polyethylene films, (modified) polyacrylic acid coating films, PVA coating films, transparent vapor deposition films, where inorganic oxide (e.g., aluminum oxide and silicon oxide) is deposited on an oriented polyethylene terephthalate film through vapor deposition, transparent barrier film (K Coat), where a base film (e.g., OPP, ONY, PET, and cellophane) is coated with polyvinylidene chloride (PVDC), and barrier films where OPP films or NY films are laminated via an ethylene-vinyl alcohol copolymer resin. The above-listed films may be disposed at the opposite side of the base to the side where the coated film is disposed.

The microwave-induced exothermic film of the present disclosure may include a printing ink layer disposed between the predetermined layers. Any typical printing ink is used for the printing ink layer. The printing ink is appropriately selected according to the base. In view of printability and ready availability, the printing ink is preferably a gravure ink including a resin, such as a urethane resin, a vinyl chloride-vinyl acetate copolymer resin, nitrocellulose, a polyamide resin, an acrylic resin, a chlorinated polypropylene resin, and a polyester resin. The gravure ink may include one or two or more of the above-listed resins. In the case where two or more color gravure inks are used, the used inks may not include the same resins, and inks including mutually different resins may be appropriately used in combination.

The microwave-induced exothermic film of the present disclosure may include an anchor coat layer between the base and the microwave-induced exothermic layer. The anchor coat layer may be transparent. Alternatively, the anchor coat layer may be formed by using an anchor coating agent including a colorant so that many different color variations and color designs are achieved.

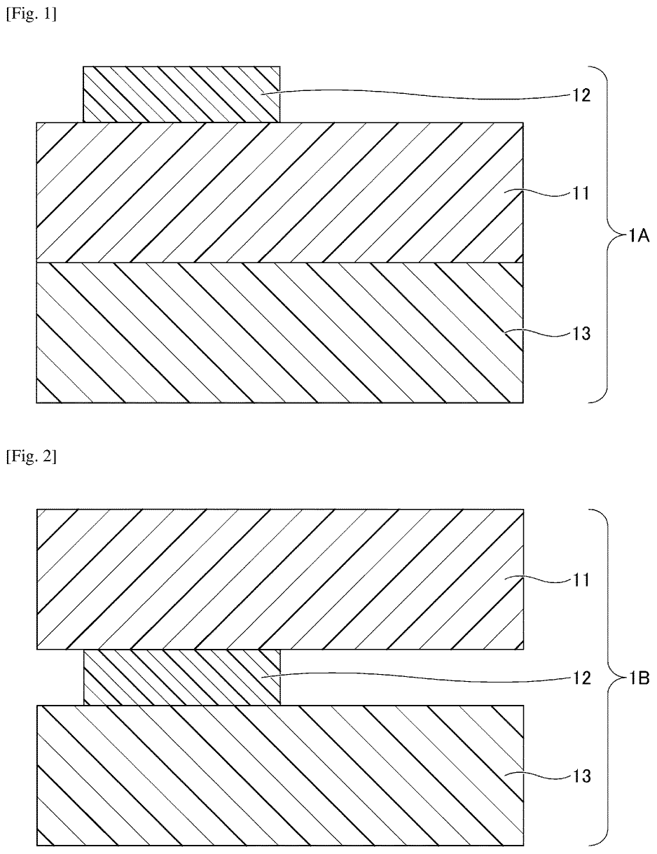

Examples of the microwave-induced exothermic film of the present disclosure are illustrated in FIGS. 1 to 5.

As illustrated in FIG. 1, the microwave-induced exothermic film 1A includes a base 11, a microwave-induced exothermic layer 12, and a sealant 13, where the sealant 13, the base 11, and the microwave-induced exothermic layer 12 are stacked in this order. The microwave-induced exothermic film 1A includes the microwave-induced exothermic layer 12 disposed on at least part of one face of the base 11, and the sealant 13 may be disposed on the entire area of the other face of the base 11. The microwave-induced exothermic layer 12 may be disposed over an entire area of one face of the base 11, and the sealant 13 may be disposed on at least part of the other face of the base 11.

As illustrated in FIG. 2, the microwave-induced exothermic film 1B has the same structure to the structure of the microwave-induced exothermic film 1A of FIG. 1, except that the base 11 and the microwave-induced exothermic layer 12 are stacked in the reverse order. Specifically, the microwave-induced exothermic film 1B includes a base 11, a microwave-induced exothermic layer 12, and a sealant 13, where the sealant 13, the microwave-induced exothermic layer 12, and the base 11 may be stacked in this order.

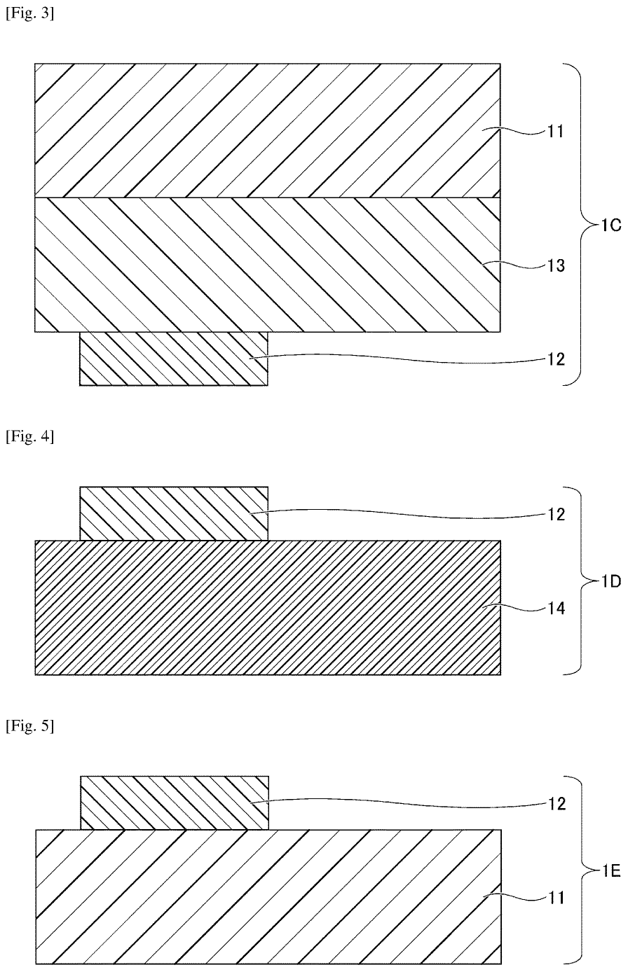

As illustrated in FIG. 3, the microwave-induced exothermic film 1C has the same structure to the structure of the microwave-induced exothermic film 1A of FIG. 1, except that the microwave-induced exothermic layer 12 may be disposed at an opposite side of the sealant 13 to the side where the base 11 is disposed. Specifically, the microwave-induced exothermic film 1C includes a base 11, a microwave-induced exothermic layer 12, and a sealant 13, where the microwave-induced exothermic layer 12, the sealant 13, and the base 11 are stacked in this order.

As illustrated in FIG. 4, the microwave-induced exothermic film 1D includes a microwave-induced exothermic layer 12 and a base 14 having sealability. The microwave-induced exothermic layer 12 may be disposed on part of one face of the base 14 having sealability.

As illustrated in FIG. 5, the microwave-induced exothermic film 1E has the same structure to the structure of the microwave-induced exothermic film 1A of FIG. 1, except that the sealant 13 is not disposed, and the base 11 and the microwave-induced exothermic layer 12 are stacked in this order.

### <Method for Producing Microwave-Induced Exothermic Film>

The method for producing a microwave-induced exothermic film according to one embodiment of the present disclosure includes forming of a microwave-induced exothermic layer including a microwave-induced exothermic composition on at least one face of a base (formation of a microwave-induced exothermic layer).

According to the above-described embodiment of the present disclosure, a method for producing a microwave-induced exothermic film achieving excellent adhesion to a base and excellent water resistance, as well as high water-vapor permeability, can be provided.

The formation of the microwave-induced exothermic layer is preferably printing to form the microwave-induced exothermic composition on the base. The printing is preferably at least one selected from the group consisting of silk screen printing, gravure printing, offset printing, flexographic printing, roller coating, brush coating, spraying, knife jet coating, and inkjet printing. Among the above-listed examples, in view of high quality and high productivity, gravure printing, flexographic printing, inkjet printing, or silk screen printing is preferred, gravure printing is more preferred, and particularly, gravure printing with a multicolor gravure printing printer is yet more preferred. Since printing is used, a coating layer may be disposed in two or more regions, and coating layers may be superimposed. Therefore, water vapor permeable openings are easily formed, and heat generation is easily controlled.

After forming a base, in which one or more films are laminated by the above-described lamination method, the microwave-induced exothermic layer may be formed on one face of the base by any of various printing methods (overprinting of the microwave-induced exothermic composition). After forming the microwave-induced exothermic layer on the face of the base by the printing method, another base may be formed on the other face of the base by any of the above-described lamination method. Moreover, the microwave-induced exothermic layer may be formed on both faces of the base.

In the case where an overcoating layer is disposed on the microwave-induced exothermic layer, the overcoating layer can be formed with an overcoating agent, overcoating varnish, or overprint varnish.

According to the method for producing the microwave-induced exothermic film of the present disclosure, printing performed to form the microwave-induced exothermic layer, the printing ink layer, and the anchor coat layer may be gravure printing by one or more units of a multicolor gravure printer. Use of gravure printing enables sequential formation of a microwave-induced exothermic layer, a printing ink layer, an anchor coat layer, etc., on a base in one production line so that a microwave-induced exothermic film can be easily produced in a sequential process flow (one pass) at low cost. Moreover, easiness of formation of a water vapor permeable opening or heat generation can be easily controlled. When the above-mentioned layers cannot be sequentially formed in one production line due to the specification of the gravure printer, the printing environment, or the facility used, the above-mentioned layers may be produced off-line (out-line).

In the case where a microwave-induced exothermic layer is formed by gravure printing, easiness of opening or heat generation is easily controlled by reducing a dot area percentage, adjusting a plate depth, or adjusting a dilution rate of the microwave-induced exothermic composition, if heat is generated excessively with a dot area percentage of 100%, or according to desired easiness of formation of a water vapor permeable opening.

The microwave-induced exothermic layer may be formed only in a region in which formation of opening is desired. Alternatively, the microwave-induced exothermic layer may be formed over an entire surface. Moreover, a different coating pattern of the microwave-induced exothermic layer, such as a pictorial pattern and a design, may be formed according to a desired shape of an opening through which water vapor is passed through, or intended easiness of opening.

Moreover, the printing is preferably gravure printing using one or more color gravure inks so that a predetermined printing ink layer may be formed on an opposite face of the base to the face on which the microwave-induced exothermic layer is disposed, or between the base and the microwave-induced exothermic layer, or between the microwave-induced exothermic layer and the anchor coat layer.

Moreover, the printing is preferably gravure printing performed by a multicolor gravure printer. The microwave-induced exothermic layer is substantially colorless, and is transparent. Since a printing ink layer can be simultaneously formed by gravure printing in one production line (in-line) without obstructing other information, such as a pictorial pattern, various colors or color designs can be imparted to the microwave-induced exothermic layer. For example, a design of a package may be imparted to enhance consumer appeal, or information regarding an opening area, an opening method, or cautions may be displayed, or information, such as a company name, a logo, a product name, illustration of a mascot, contents, ingredients, notification or application method of promotions, a method of easing or using, date, a place of production, and raffle numbers, may be imparted.

Moreover, the method may further include formation of an intermediate layer, an anchor coat layer, or an overcoating layer. The formation of the above-listed layers is not particularly limited, except that any of formation methods available in the related art, such as bonding and coating, is used.

Each composition, such as the microwave-induced exothermic composition, the printing ink, and the anchor coating agent, can be produced by homogeneously dissolving or dispersing an electroconductive organic compound, a resin, a pigment, a sealable resin, various additives etc., in a solvent according to any method available in the related art. For the dissolving or dispersing, various stirrers or dispersers, such as dissolvers, roll mills, ball mills, bead mills, sand mills, attritors, paint shakers, agitators, HENSCHEL mixers, colloid mills, pearl mills, ultrasonic homogenizers, wet jet mills, kneaders, and homomixers, may be used. The above-listed stirrers or dispersers may be used alone or in combination. In the case where air bubbles or coarse particles are included in the composition, such air bubbles or coarse particles impair printability of the composition or quality of print. Therefore, air bubbles or coarse particles are preferably removed from the composition using a filtration device or centrifuge available in the related art.

A viscosity of the above-mentioned composition is not particularly limited, as long as printing of the composition can be carried out without any problem. In view of suitability for production and handling of the composition, the viscosity of the composition at 25 degrees Celsius is preferably from 10 millipascal-seconds to 1,000 millipascal-seconds. In the case where the composition is used as a gravure printing ink, the viscosity of the composition is more preferably from 10 millipascal-seconds to 500 millipascal-seconds.

The viscosity may be measured by a commercially available viscometer, such as a Brookfield viscometer.

The microwave-induced exothermic film of the present disclosure includes a microwave-induced exothermic layer, where the microwave-induced exothermic layer includes the above-described microwave-induced exothermic composition of the present disclosure. When the microwave-induced exothermic film is arranged in a manner such that the microwave-induced exothermic layer overlaps the heat-sealing section, the microwave-induced exothermic layer generates heat through microwave irradiation so that an opening is formed in the heat-sealing section due to the shrinkage of the film. When the microwave-induced exothermic layer is arranged at a central section of the microwave-induced exothermic film, an opening is easily formed in the central section due to the breakage of the microwave-induced exothermic film. Therefore, the microwave-induced exothermic film of the present disclosure achieves excellent adhesion to the base and water resistance. As the microwave-induced exothermic film of the present disclosure can generate heat through microwave irradiation during microwave heating, an opening is easily formed in the microwave-induced exothermic film so that high water-vapor permeability can be achieved.

Since the microwave-induced exothermic film of the present disclosure has the above-described properties, the microwave-induced exothermic film is suitably used as a microwave-induced exothermic film for a package, and can be particularly effectively used as a microwave-induced exothermic film for a water vapor permeable package.

### <Microwave-Induced Exothermic Package>

The microwave-induced exothermic package of the present disclosure includes the above-described microwave-induced exothermic film of the present disclosure, where a microwave-induced exothermic layer is formed at least at part of the microwave-induced exothermic film. The microwave-induced exothermic film may constitute an entire part of a package body of the microwave-induced exothermic package, or only part of the package body of the microwave-induced exothermic package.

The microwave-induced exothermic package may be selected from embodiments typically used for microwave-induced exothermic sheets. The package body of the microwave-induced exothermic package may be a 2 side seal pouch, a 3 side seal pouch, a 4 side seal pouch, a pillow seal pouch, a standing pouch, a lap seal pouch, a gusset bag, a fusion sealable package, a tube, a toffee wrapper, an overholding wrapping package, a fin-sealed package, a dumpling wrapper, a wrapper with twisted ends, a pouch with clipped ends, Tetra Pak (registered trademark), a gable top package, a brick carton, a vacuum packaging, a cup, a tray, a bottle, a container, a box, a case, a food tray, a cover, a lid, a cap, a covering material, a label, or a sheet.

A method for producing the microwave-induced exothermic package preferably includes formation of a package using the microwave-induced exothermic film.

The formation may include shaping of the microwave-induced exothermic film into a package. One sheet of the microwave-induced exothermic film may be folded in half, and the both edges of the folded film may be sealed to form a bag. Moreover, two sheets of the microwave-induced exothermic film may be stacked so that the microwave-induced exothermic layers face each other, and the both edges of the stacked films are sealed to form a bag.

Moreover, the formation may include covering a container with the microwave-induced exothermic film to form a package.

For the formation, any method used for forming typical packages, such as a 2 side seal pouch, a 3 side seal pouch, a 4 side seal pouch, a pillow seal pouch, a standing pouch, a lap seal pouch, a gusset bag, a fusion sealable package, a tube, a toffee wrapper, an overholding wrapping package, a fin-sealed package, a dumpling wrapper, a wrapper with twisted ends, a pouch with clipped ends, Tetra Pak (registered trademark), a gable top package, a brick carton, a vacuum packaging, a cup, a tray, a bottle, a container, a box, a case, a food tray, a cover, a lid, a cap, a covering material, a label, and a sheet, may be used.

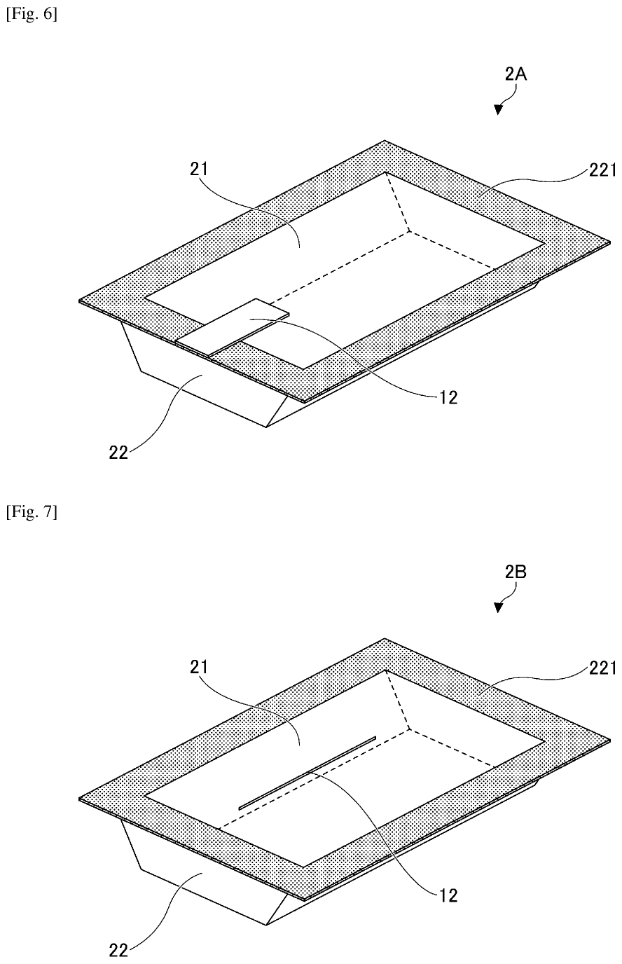

Examples of the structure of the microwave-induced exothermic package of the present disclosure are illustrated in FIGS. 6 and 7.

As illustrated in FIG. 6, the microwave-induced exothermic package 2A includes a lid 21 and a container 22. The microwave-induced exothermic package 2A is a package container where the lid 21 is sealed on a heat-sealing section 221 of the container 22 through heat-sealing.

The lid 21 may be any of the above-described microwave-induced exothermic films 1A to 1E of the present disclosure. The lid 21 may be formed so that part of the microwave-induced exothermic layer 12 is positioned over the heat-sealing section 221.

The microwave-induced exothermic layer 12 is linearly arranged on the lid 21, but the arrangement of the microwave-induced exothermic layer 12 may be changed according to contents of the container 22, an inner volume of the container 22, or a shape of the container 22. The microwave-induced exothermic layer 12 may be in the shape of a circle or a rectangle, and the microwave-induced exothermic layer 12 may be disposed in two or more areas of the lid 21.

The microwave-induced exothermic layer 12 is disposed substantially at a center of the upper edge of the short side of the container 22, but the microwave-induced exothermic layer 12 may be disposed at any part of the heat-sealing section.

The container 22 is substantially an upside-down truncated rectangular pyramid, but the container 22 may have another shape, such as a cylinder, a cube, and a triangular prism, according to contents or intended use.

The container 22 has a heat-sealing section 221 at an upper part of the container 22. The heat-sealing section 221 is formed into a flat plane to be in contact with the lid 21. The lid 21 and the container 22 are joined together at the heat-sealing section 221.

As the microwave-induced exothermic package 2A is irradiated with microwaves, the microwave-induced exothermic layer 12 generates heat to soften the heat-sealing section 221. As a result, an opening may be formed between the lid 21 and the container 22 by the increased internal pressure due to the water vapor generated from the contents including moisture. The water vapor is released from the opening.

As illustrated in FIG. 7, the microwave-induced exothermic package 2B is a package container having the same structure as the structure of the microwave-induced exothermic package 2A, except that the position of the microwave-induced exothermic layer 12 is changed to a position that does not overlaps the heat-sealing section 221 of the container 22. The microwave-induced exothermic layer 12 may be disposed substantially at a center of the lid 21 along the longitudinal direction of the lid 21.

As the microwave-induced exothermic package 2B is irradiated with microwaves, the microwave-induced exothermic layer 12 generates heat to break or soften the section of the lid 21 to which the microwave-induced exothermic layer 12 is disposed to a degree that the lid 21 can break by vapor pressure. As a result, an opening from which water vapor generated from the contents including mixture is released may be formed.

The microwave-induced exothermic package of the present disclosure includes a microwave-induced exothermic layer, where the microwave-induced exothermic layer includes the above-described microwave-induced exothermic composition of the present disclosure. Therefore, the microwave-induced exothermic layer of the microwave-induced exothermic package of the present disclosure generates heat through microwave irradiation. When the microwave-induced exothermic layer is disposed to overlap with a heat-sealing section of the microwave-induced exothermic package, an opening is easily formed in the heat-sealing section as the film is shrunk with the heat generated by the microwave-induced exothermic layer. When the microwave-induced exothermic layer is disposed in a central section of the microwave-induced exothermic package, an opening is easily formed in the central section as the microwave-induced exothermic film is broken or torn with the heat generated by the microwave-induced exothermic layer. As heat is generated through microwave irradiation during microwave heating, an opening is easily formed in the microwave-induced exothermic package of the present disclosure to achieve high water-vapor permeability, as well as achieving excellent adhesion to a base and excellent water resistance.

Since the microwave-induced exothermic package of the present disclosure has the above-described properties, the microwave-induced exothermic package is suitably used as a microwave-assisted exothermic package, such as packages for microwave heating.

Since the microwave-induced exothermic package of the present disclosure has excellent adhesion to a base and excellent water resistance, as well as high water-vapor permeability, the microwave-induced exothermic package is suitably used for packages that form through-hole(s) by microwave irradiation. For example, moreover, the microwave-induced exothermic package of the present disclosure is suitably applied for a cooking sheet used for browning food products by microwave irradiation.

As described above, embodiments of the present invention have been described. The embodiments are described merely as examples, and the present invention is not limited to these embodiments. The embodiments may be carried out in various combination and omission, substitution, or modification may be made in the embodiments without departing from the scope of the present invention. The embodiments and modified embodiments are within the scope of the present invention, as well as being within the scope equivalent to the invention defined in the scope of claims.

### EXAMPLES

The present disclosure will be described hereinafter by way of Examples and Comparative Examples. Examples should not be construed as to limit the scope of the present disclosure.

### <Production of Microwave-Induced Exothermic Composition>

### Production Example 1

With 100 parts by mass of a PEDOT:PSS solution (ORGACON S315, available from AGFA Materials Japan, LTD.) including PEDOT serving as an electroconductive polymer and PSS serving as a dopant, 1.5 parts by mass of a styrene-butadiene copolymer (SR102, available from NIPPON A&L INC., glass transition temperature (Tg): 21 degrees Celsius) and 30 parts by mass of ethanol were mixed, and the resulting mixture was stirred for 30 minutes to prepare a microwave-induced exothermic composition 1, in which an amount of the resin was 50% by mass relative to the solid content of the microwave-induced exothermic composition.

### Production Example 2

A microwave-induced exothermic composition 2 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 1.8 parts by mass of a styrene-butadiene copolymer (LX432M, available from Zeon Corporation, glass transition temperature (Tg): −58 degrees Celsius). In the microwave-induced exothermic composition 2, an amount of the resin was 50% by mass relative to the solid content of the microwave-induced exothermic composition.

### Production Example 3

A microwave-induced exothermic composition 3 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 1.6 parts by mass of a styrene-butadiene copolymer (SR107, available from NIPPON A&L INC., glass transition temperature (Tg): −15 degrees Celsius). In the microwave-induced exothermic composition 3, an amount of the resin was 50% by mass relative to the solid content of the microwave-induced exothermic composition.

### Production Example 4

A microwave-induced exothermic composition 4 was produced in the same manner as in Production Example 1, except that the amount of the styrene-butadiene copolymer (SR102, available from NIPPON A&L INC., glass transition temperature (Tg): 21 degrees Celsius) was changed from 1.5 parts by mass to 0.1 parts by mass. In the microwave-induced exothermic composition 4, an amount of the resin was 5% by mass relative to the solid content of the microwave-induced exothermic composition.

### Production Example 5

A microwave-induced exothermic composition 5 was produced in the same manner as in Production Example 1, except that the amount of the styrene-butadiene copolymer (SR102, available from NIPPON A&L INC., glass transition temperature (Tg): 21 degrees Celsius) was changed from 1.5 parts by mass to 0.2 parts by mass. In the microwave-induced exothermic composition 5, an amount of the resin was 10% by mass relative to the solid content of the microwave-induced exothermic composition.

### Production Example 6

A microwave-induced exothermic composition 6 was produced in the same manner as in Production Example 1, except that the amount of the styrene-butadiene copolymer (SR102, available from NIPPON A&L INC., glass transition temperature (Tg): 21 degrees Celsius) was changed from 1.5 parts by mass to 13.9 parts by mass. In the microwave-induced exothermic composition 6, an amount of the resin was 90% by mass relative to the solid content of the microwave-induced exothermic composition.

### Production Example 7

A microwave-induced exothermic composition 7 was produced in the same manner as in Production Example 1, except that the amount of the styrene-butadiene copolymer (SR102, available from NIPPON A&L INC., glass transition temperature (Tg): 21 degrees Celsius) was changed from 1.5 parts by mass to 29.3 parts by mass. In the microwave-induced exothermic composition 7, an amount of the resin was 95% by mass relative to the solid content of the microwave-induced exothermic composition.

### Production Example 8

A microwave-induced exothermic composition 8 was produced in the same manner as in Production Example 1, except that the PEDOT:PSS solution was replaced with 100 parts by mass of a dodecylbenzene sulfonate-doped polyaniline (available from Sigma-Aldrich) solution. In the microwave-induced exothermic composition 8, an amount of the resin was 50% by mass relative to the solid content of the microwave-induced exothermic composition.

### Production Example 9

A microwave-induced exothermic composition 9 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 1.7 parts by mass of an acrylonitrile-butadiene copolymer (1571C2, available from Zeon Corporation, glass transition temperature (Tg): −16 degrees Celsius). In the microwave-induced exothermic composition 9, an amount of the resin was 50% by mass relative to the solid content of the microwave-induced exothermic composition.

### Production Example 10

A microwave-induced exothermic composition 10 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 1.6 parts by mass of a vinyl acetate resin (MI-17, available from Nisshin Chemical Co., Ltd., glass transition temperature (Tg): 35 degrees Celsius). In the microwave-induced exothermic composition 10, an amount of the resin was 50% by mass relative to the solid content of the microwave-induced exothermic composition.

### Production Example 11

A microwave-induced exothermic composition 11 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 1.8 parts by mass of a silicone resin (DOWSIL RSN-0255, available from Dow Toray Co., Ltd., glass transition temperature (Tg): 56 degrees Celsius). In the microwave-induced exothermic composition 11, an amount of the resin was 50% by mass relative to the solid content of the microwave-induced exothermic composition.

### Production Example 12

A microwave-induced exothermic composition 12 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 2.5 parts by mass of an acrylic resin (63J, available from BASF, glass transition temperature (Tg): 73 degrees Celsius). In the microwave-induced exothermic composition 12, an amount of the resin was 50% by mass relative to the solid content of the microwave-induced exothermic composition.

### Production Example 13

A microwave-induced exothermic composition 13 was produced in the same manner as in Production Example 1, except that 1.5 parts by mass of the styrene-butadiene copolymer (SR102, available from NIPPON A&L INC., glass transition temperature (Tg): 21 degrees Celsius) was replaced with 1.5 parts by mass of a urethane resin (6820, available from Japan Coating Resin Corporation, glass transition temperature (Tg): 25 degrees Celsius). In the microwave-induced exothermic composition 13, an amount of the resin was 50% by mass relative to the solid content of the microwave-induced exothermic composition.

### Production Example 14

With 100 parts by mass of a PEDOT:PSS solution (ORGACON S315, available from AGFA Materials Japan, LTD.), 30 parts by mass of ethanol was mixed, and the resulting mixture was stirred for 30 minutes, to prepare a microwave-induced exothermic composition 14.

The electroconductive polymer, the dopant, and the resin included in the microwave-induced exothermic composition of each of Production Examples are presented in Table 1.

TABLE 1

| | Microwave-induced exothermic composition | | | |
|---|---|---|---|---|
| | | Resin | | |
| | | | Amount relative to solid | |
| | | | content of microwave- | |
| | Electroconductive | | induced exothermic | Tg |
| | polymer + dopant | Type | composition [mass %] | [° C.] |
| Production Example 1 | PEDOT:PSS | Styrene-butadiene | 50 | 21 |
| | | copolymer | | |
| Production Example 2 | PEDOT:PSS | Styrene-butadiene | 50 | −58 |
| | | copolymer | | |
| Production Example 3 | PEDOT:PSS | Styrene-butadiene | 50 | −15 |
| | | copolymer | | |
| Production Example 4 | PEDOT:PSS | Styrene-butadiene | 5 | 21 |
| | | copolymer | | |
| Production Example 5 | PEDOT:PSS | Styrene-butadiene | 10 | 21 |
| | | copolymer | | |
| Production Example 6 | PEDOT:PSS | Styrene-butadiene | 90 | 21 |
| | | copolymer | | |
| Production Example 7 | PEDOT:PSS | Styrene-butadiene | 95 | 21 |
| | | copolymer | | |
| Production Example 8 | Dodecylbenzene | Styrene-butadiene | 50 | 21 |
| | sulfonate-doped | copolymer | | |
| | polyaniline | | | |
| Production Example 9 | PEDOT:PSS | Acrylonitrile-butadiene | 50 | −16 |
| | | copolymer | | |
| Production Example 10 | PEDOT:PSS | Vinyl acetate resin | 50 | 35 |
| Production Example 11 | PEDOT:PSS | Silicone resin | 50 | 56 |
| Production Example 12 | PEDOT:PSS | Acrylic resin | 50 | 73 |
| Production Example 13 | PEDOT:PSS | Urethane resin | 50 | 25 |
| Production Example 14 | PEDOT:PSS | No resin | — | — |

### <Production of Microwave-Induced Exothermic Film>

### Examples 1 to 18 and Comparative Example 1 to 6

The microwave-induced exothermic composition of each of Production Examples was applied to a predetermined area of a heat-seal PET film serving as a base. The predetermined area was a “heat-sealing section” or “central section” having the predetermined size. The applied microwave-induced exothermic composition was dried at 90 degrees Celsius for 5 minutes, followed by storing at 25 degrees Celsius for 24 hours, to thereby produce a microwave-induced exothermic film, in which a microwave-induced exothermic layer (coating film or coating layer) was formed on the heat seal PET film.

In the case where the coated area was the “heat-sealing section” of the heat seal PET film, the microwave-induced exothermic composition was applied in the size of 5 cm in length and 5 cm in width as viewed horizontally, and heat sealing was performed by arranging the microwave-induced exothermic layer in a manner that the length direction (the long side) of the microwave-induced exothermic layer overlapping the heat-sealing section and was arranged to be vertical to the sealing section.

In the case where the coated area was the “central section” of the heat seal PET film, the microwave-induced exothermic composition was applied in the size of 10 cm in length and 1 cm in width as viewed horizontally, and heat sealing was performed by arranging the microwave-induced exothermic layer to be in the central part of the container.

The sealing was performed in the following manner. A paper wipe (KIM TOWEL, available from NIPPON PAPER CRECIA CO., LTD.) soaking 50 g of water was placed in a container formed of PP, and the container and the film to which the microwave-induced exothermic composition was applied were sealed together by heat sealing at 180 degrees Celsius for 1 second.

The microwave-induced exothermic composition used in the microwave-induced exothermic film of each of Examples and Comparative Examples, and the area of the heat seal PET film coated with the microwave-induced exothermic composition in each of Examples and Comparative Examples are presented in Table 2.

TABLE 2

| | Microwave-induced exothermic layer | |
|---|---|---|
| | Microwave-induced exothermic | |
| | composition (Production Example) | Coated area |
| Ex. 1 | Production Example 1 | Central section |
| Ex. 2 | Production Example 2 | Central section |
| Ex. 3 | Production Example 3 | Central section |
| Ex. 4 | Production Example 4 | Central section |
| Ex. 5 | Production Example 5 | Central section |
| Ex. 6 | Production Example 6 | Central section |
| Ex. 7 | Production Example 7 | Central section |
| Ex. 8 | Production Example 8 | Central section |
| Ex. 9 | Production Example 9 | Central section |
| Ex. 10 | Production Example 10 | Central section |
| Ex. 11 | Production Example 11 | Central section |
| Ex. 12 | Production Example 1 | Heat-sealing section |
| Ex. 13 | Production Example 2 | Heat-sealing section |
| Ex. 14 | Production Example 3 | Heat-sealing section |
| Ex. 15 | Production Example 4 | Heat-sealing section |
| Ex. 16 | Production Example 5 | Heat-sealing section |
| Ex. 17 | Production Example 6 | Heat-sealing section |
| Ex. 18 | Production Example 7 | Heat-sealing section |
| Comp. Ex. 1 | Production Example 12 | Central section |
| Comp. Ex. 2 | Production Example 13 | Central section |
| Comp. Ex. 3 | Production Example 14 | Central section |
| Comp. Ex. 4 | Production Example 12 | Heat-sealing section |
| Comp. Ex. 5 | Production Example 13 | Heat-sealing section |
| Comp. Ex. 6 | Production Example 14 | Heat-sealing section |

### <Evaluations>

As evaluations of the microwave-induced exothermic film of each of Examples and Comparative Examples, water resistance, adhesion to a base, and water-vapor permeability were measured and evaluated in the following manner.

### (Water Resistance)

A surface of the microwave-induced exothermic layer of the microwave-induced exothermic film of each of Examples and Comparative Example was tested by touching with a finger after immersing the microwave-induced exothermic film in water for 1 hour, and after taking microwave-induced exothermic film out from the water. The result was evaluated based on the following evaluation criteria.

### ((Evaluation Criteria))

A: After immersing the microwave-induced exothermic film in water and taking out from the water, the microwave-induced exothermic layer was not peeled off from the base when touched with a finger.
B: The microwave-induced exothermic layer was not peeled off from the base while the microwave-induced exothermic film was immersed in water, but less than 30% of the microwave-induced exothermic layer was peeled off from the base, relative to a total area of the microwave-induced exothermic layer, when touched with a finger.
C: The microwave-induced exothermic layer was not peeled off from the base while the microwave-induced exothermic film was immersed in water, but 30% or greater of the microwave-induced exothermic layer was peeled off from the base, relative to a total area of the microwave-induced exothermic layer, when touched with a finger.
D: The microwave-induced exothermic layer was peeled off from the base while the microwave-induced exothermic film was immersed in water.

### (Adhesion to a Base)

A piece of Cellotape (registered trademark) (CT405AP-18, available from NICHIBAN CO., LTD.) was adhered onto the microwave-induced exothermic layer of the microwave-induced exothermic film of each of Examples and Comparative Examples. Then, the adhered Cellotape was peeled off at the following three stages to evaluate the presence or absence of peeling of the microwave-induced exothermic layer based on the following evaluation criteria.

((Peeling stage))
1st: Cellotape (registered trademark) was slowly peeled off at an angle of 180 degrees relative to the sample.
2nd: Cellotape (registered trademark) was quickly peeled off at an angle of 180 degrees relative to the sample.
3rd: Cellotape (registered trademark) was quickly peeled off at an angle of 90 degrees relative to the sample.

### ((Evaluation Criteria))

A: There was no peeling of the microwave-induced exothermic layer in the 3rd stage.
B: There was peeling of the microwave-induced exothermic layer in the 3rd stage.
C: There was peeling of the microwave-induced exothermic layer in the 2nd stage.
D: There was peeling of the microwave-induced exothermic layer in the 1st stage.

### (Water-Vapor Permeability)

A container and the film sealed by heat sealing were heated in a microwave (RE-7500, available from Sharp Corporation) at 500 W for 120 seconds, and water-vapor permeability was evaluated based on the following evaluation criteria.

((Evaluation criteria))
A: The steam was released from the area coated with microwave-induced exothermic layer.
B: The steam was released from the area other than the area coated with microwave-induced exothermic layer.

The evaluation results of water resistance, adhesion to a base, and water-vapor permeability of the microwave-induced exothermic layer are presented in Table 3.

TABLE 3

| | Microwave-induced exothermic layer | | |
|---|---|---|---|
| | | | Water-vapor |
| | Water resistance | Adhesion to base | permeability |
| Ex. 1 | A | A | A |
| Ex. 2 | A | B | A |
| Ex. 3 | A | A | A |
| Ex. 4 | B | A | A |
| Ex. 5 | A | A | A |
| Ex. 6 | A | A | A |
| Ex. 7 | A | A | B |
| Ex. 8 | A | A | A |
| Ex. 9 | A | A | A |
| Ex. 10 | A | A | A |
| Ex. 11 | A | A | A |
| Ex. 12 | A | A | A |
| Ex. 13 | A | B | A |
| Ex. 14 | A | A | A |
| Ex. 15 | B | A | A |
| Ex. 16 | A | A | A |
| Ex. 17 | A | A | A |
| Ex. 18 | A | A | B |
| Comp. Ex. 1 | D | C | A |
| Comp. Ex. 2 | C | C | A |
| Comp. Ex. 3 | D | C | A |
| Comp. Ex. 4 | D | C | A |
| Comp. Ex. 5 | C | C | A |
| Comp. Ex. 6 | D | C | A |

It was found from the results of Table 3 that the microwave-induced exothermic layers of Examples 1 to 18 generated heat through microwave irradiation to form an opening so that high permeability was achieved, as well as achieving excellent adhesion to the base and excellent water resistance, compared to the microwave-induced exothermic layers of Comparative Examples 1 to 6.

As demonstrated above, when a microwave-induced exothermic layer is formed by using a microwave-induced exothermic composition including an electroconductive polymer and a resin including a styrene-butadiene copolymer, an acrylonitrile-butadiene copolymer, a vinyl acetate resin or a silicone resin, a microwave-induced exothermic film or microwave-induced exothermic package including the above-described microwave-induced exothermic layer can achieve excellent water resistance and excellent adhesion to a base, while achieving high water-vapor permeability.

For example, embodiment of the present disclosure are as follows.
<1> A microwave-induced exothermic composition, including:
an electroconductive polymer; and
a resin that is at least one selected from the group consisting of a styrene-butadiene copolymer, an acrylonitrile-butadiene copolymer, a vinyl acetate resin, and a silicone resin.
<2> A microwave-induced exothermic composition, including:
an electroconductive polymer; and
a resin that is at least one selected from the group consisting of an acrylonitrile-butadiene copolymer and a silicone resin.
<3> A microwave-induced exothermic composition, including:
an electroconductive polymer; and
a resin that is at least one selected from the group consisting of a styrene-butadiene copolymer, an acrylonitrile-butadiene copolymer, a vinyl acetate resin, and a silicone resin,
wherein the resin has a glass transition temperature of minus 20 degrees Celsius or higher.
<4> The microwave-induced exothermic composition according to <1> or <2>,
wherein the resin has a glass transition temperature of minus 20 degrees Celsius or higher.
<5> The microwave-induced exothermic composition according to any one of <1> to <4>,
wherein an amount of the resin is from 10% by mass to 90% by mass relative to a solid content of the microwave-induced exothermic composition.
<6> The microwave-induced exothermic composition according to any one of <1> to <5>, further including a dopant.
<7> The microwave-induced exothermic composition according to any one of <1> to <6>, further including a high boiling point solvent having a boiling point of from 100 degrees Celsius to 350 degrees Celsius.
<8> A microwave-induced exothermic layer, including:
an electroconductive polymer; and
a resin that is at least one selected from the group consisting of a styrene-butadiene copolymer, an acrylonitrile-butadiene copolymer, a vinyl acetate resin, and a silicone resin,
wherein the microwave-induced exothermic layer has a thickness of 0.01 micrometers to 10 micrometers.
<9> A microwave-induced exothermic film, including:
a base; and
the microwave-induced exothermic layer of <8> on at least one face of the base.
<10> A microwave-induced exothermic package, including:
a package body including the microwave-induced exothermic film of <9>, the microwave-induced exothermic film constituting an entire part of or a part of the package body.
<11> A method for producing a microwave-induced exothermic film, the method including:
forming a microwave-induced exothermic layer on at least one face of a base, the microwave-induced exothermic layer including a microwave-induced exothermic composition, and
the microwave-induced exothermic composition including an electroconductive polymer and a resin that is at least one selected from the group consisting of a styrene-butadiene copolymer, an acrylonitrile-butadiene copolymer, a vinyl acetate resin, and a silicone resin.

The present application is based on and claims priority to Japanese patent application No. 2023-041347 filed on Mar. 15, 2023, with the Japanese Patent Office, the entire contents of which are hereby incorporated by reference.

### DESCRIPTION OF REFERENCE NUMERAL

1A to 1E microwave-induced exothermic film
11 base
12 microwave-induced exothermic layer
13 sealant
14 sealable base
2A, 2B microwave-induced exothermic package
21 lid
22 container
221 heat-sealing section

1. A microwave-induced exothermic composition, comprising:
an electroconductive polymer; and
a resin that is at least one selected from the group consisting of a styrene-butadiene copolymer, an acrylonitrile-butadiene copolymer, a vinyl acetate resin, and a silicone resin.

2. The microwave-induced exothermic composition according to claim 1,
wherein the resin has a glass transition temperature of minus 20 degrees Celsius or higher.

3. The microwave-induced exothermic composition according to claim 1,
wherein an amount of the resin is from 10% by mass to 90% by mass relative to a solid content of the microwave-induced exothermic composition.

4. The microwave-induced exothermic composition according to claim 1, further comprising:
a dopant.

5. The microwave-induced exothermic composition according to claim 1, further comprising:
a high boiling point solvent having a boiling point of from 100 degrees Celsius to 350 degrees Celsius.

6. A microwave-induced exothermic layer, comprising:
an electroconductive polymer; and
a resin that is at least one selected from the group consisting of a styrene-butadiene copolymer, an acrylonitrile-butadiene copolymer, a vinyl acetate resin, and a silicone resin,
wherein the microwave-induced exothermic layer has a thickness of 0.01 micrometers to 10 micrometers.

7. A microwave-induced exothermic film, comprising:
a base; and
the microwave-induced exothermic layer of claim 6, disposed on at least one face of the base.

8. A microwave-induced exothermic package, comprising:
a package body including the microwave-induced exothermic film of claim 7, the microwave-induced exothermic film constituting an entire part of or a part of the package body.

9. A method for producing a microwave-induced exothermic film, the method comprising:
forming a microwave-induced exothermic layer on at least one face of a base,
the microwave-induced exothermic layer including a microwave-induced exothermic composition, and
the microwave-induced exothermic composition including an electroconductive polymer and a resin that is at least one selected from the group consisting of a styrene-butadiene copolymer, an acrylonitrile-butadiene copolymer, a vinyl acetate resin, and a silicone resin.
